(19) United States
(12) Patent Application Publication
(10) Pub. No.: US 2019/0233639 A1
(43) Pub. Date: Aug. 1, 2019

(54) POLYALKYLENE TEREPHTHALATE COMPOSITIONS

(71) Applicant: LANXESS Deutschland GmbH, Cologne (DE)

(72) Inventors: Boris NEUWALD, Cologne (DE); Matthias BIENMUELLER, Krefeld (DE)

(73) Assignee: LANXESS Deutschland GmbH, Cologne (DE)

(21) Appl. No.: 16/330,981

(22) PCT Filed: Aug. 14, 2017
(86) PCT No.: PCT/EP2017/070565

§ 371 Date: Mar. 6, 2019

(30) Foreign Application Priority Data
Sep. 6, 2016 (EP) 16187333.6

(51) Int. Cl. C08L 67/02; C08L 23/08; C08K 5/1515; C08K 5/13; C08F 220/18; B29C 48/00; B29C 45/00

(52) U.S. Cl. CPC C08L 67/02; C08L 23/0869; C08K 5/1515; C08K 5/13; B29K 2023/08; B29C 48/022; B29C 45/0001; C08L 2205/03; C08F 2500/12; C08F 220/18

(57) ABSTRACT

The invention relates to novel, optionally reinforced, compositions based on a) polyalkylene terephthalates, preferably polybutylene terephthalate, b) at least one copolymer of at least one olefin and at least one (meth)acrylic ester of an aliphatic alcohol and c) at least one additive based on molecules having 2 or more epoxy, anhydride or carbodiimide groups per molecule, to molding materials producible therefrom and in turn to hydrolysis-stable articles of manufacture having good surfaces coupled with good mechanical properties producible from the molding materials.

The invention relates to novel, optionally reinforced, compositions based on a) polyalkylene terephthalates, preferably polybutylene terephthalate, b) at least one copolymer of at least one olefin and at least one (meth)acrylic ester of an aliphatic alcohol and c) at least one additive based on molecules having 2 or more epoxy, anhydride or carbodiimide groups per molecule, to molding materials producible therefrom and in turn to hydrolysis-stable articles of manufacture having good surfaces coupled with good mechanical properties producible from the molding materials.

Polyalkylene terephthalates generally feature good processability, good mechanical properties, heat stability and chemical stability. They are employed in numerous applications, preferably in injection molding, for film production or for fiber production. Preferred articles of manufacture based on polyalkylene terephthalates are switches, housings, plugs, sensors and further applications in the electricals and electronics sector.

Important for polyalkylene terephthalates in the abovementioned applications is problem-free processing, in particular in respect of hot runner systems, and a highest possible melt stability at elevated temperatures, wherein elevated temperatures are understood by those skilled in the art to mean temperatures in the range of >260° C. but below the decomposition temperature.

Melt stability describes the change over time in melt viscosity at elevated temperatures. In a non-additized polyalkylene terephthalate, melt viscosity decreases with time. However, reactive chain-extending additives, for example molecules containing two or more epoxy groups, can also be used to increase melt viscosity. This is disadvantageous since the flowability of the melt decreases which can lead, inter alia, to reduced processing speeds. Furthermore, en increase in melt viscosity can lead to specks or to solidification of the injection molding material in the nozzle to be employed in injection molding or to blockages/closures in the feed system (hot runner) of an injection molding plant. Molding materials having a high melt stability are therefore hereinbelow to be understood as meaning those exhibiting no increase in melt viscosity even after residence times >5 min at markedly above the melting point of the molding material, preferably >260° C. As is known to those skilled in the art such melt-stable molding materials typically undergo a slight reduction in melt viscosity during processing.

According to https://de.wikipedia.org/wiki/Stippe_Kunstoff) a speck is a surface defect in an injection molding. In the context of the present invention organic specks consisting of degraded, i.e. thermally decomposed, polymer will be considered.

The lack of an increase in melt viscosity during processing of a molding material thus contributes to a reduction of specks and to an improvement in the surface quality and therefore reduces scrap in the injection molding process.

In molding materials, the use of additives having 2 or more epoxy, anhydride or carbodiimide groups generally results in a reduction in flowability by increasing the melt viscosity. In addition, elevated temperatures can bring about an increase in melt viscosity during processing, thus leading to severe problems in processing.

EP 1 992 862 A2 describes thermoplastic molding materials having improved flowability based on a thermoplastic polyester and a copolymer of at least one olefin with at least one methacrylic ester of an aliphatic alcohol, wherein the MFI (melt flow index) of the copolymer is not less than 100 g/10 min, a process for producing these molding materials and the use of these molding materials for producing moldings for the electricals, electronics, telecommunications, motor vehicle and computer industries and also in the sports, medical, household or entertainment sector.

WO 2007/147490 A1 relates to a process for producing impact-modified polyalkylene terephthalate/polycarbonate compositions and discloses compositions composed of polybutylene terephthalate, ethane-alkyl acrylate copolymer and glycidyl ester copolymers having an MFI of 28-7.0.

WO 2015/195143 A1 also describes polyalkylene terephthalate/polycarbonate blends admixed with a diglycidyl ether of bisphenol A.

WO2014/035472 A1 shows that polyester mixtures containing epoxidic stabilizers for example have a propensity for viscosity increases at high temperatures. The addition of hydroxyapatite to polyester mixtures comprising additives containing reactive components (having two or more epoxy functionalities per molecule) results in an increase in melt stability.

However, WO2014/035472 A1 discloses intentionally adding a chain-decomposing mineral substance which under disadvantageous conditions could also result in excessive degradation of the polymer chains and thus in a loss of mechanical properties in the end product. This impedes correct use in practice very significantly.

The problem addressed by the present invention is that of providing polyalkylene terepthalate mixtures in the form of inventive compositions and molding materials which have a high melt stability under processing conditions and show no increase in melt viscosity in the course of or as a consequence of processing. Simultaneously, the molding materials according to the invention shall exhibit a low melt viscosity, a good flow behavior during processing and the articles of manufacture producible therefrom shall have a high hydrolysis resistance which is not reduced by addition of a flow promoter.

The problem is solved by the subject matter of the present invention which comprises compositions, molding materials and articles of manufacture containing
a) at least one polyalkylene terephthalate,
b) at least one copolymer of at least one olefin and at least one acrylic ester or methacrylic ester of an aliphatic alcohol, wherein the melt flow index (MFI) according to ISO 1133 of the copolymer is not less than 50 g/10 min, preferably 150 g610 min, and said index is measured/determined at 190° C. and a test weight of 2.16 kg, and
c) at least one additive based on molecules having 2 or more epoxy, anhydride or carbodiimide groups per molecule.

Surprisingly, the combination of the components b) and c) results in inventive polyalkylene terepthalate-based compositions and molding materials producible therefrom which exhibit a high melt stability under processing conditions, i.e. no increase in melt viscosity, and articles of manufacture producible from the molding materials feature good surfaces and good mechanical properties and exhibit a high hydrolysis resistance which is not reduced by addition of a flow promoter as shown in the examples section.

### Definitions

In one embodiment the present invention relates to reinforced compositions, molding materials or articles of manufacture which feature the presence of at least one filler or reinforcer.

Melt-stable molding materials are to be understood as meaning those exhibiting no increase in melt viscosity even after residence times >5 min at markedly above the melting point, preferably above 260° C. but below the decomposition temperature. According to the invention a slight reduction in the melt viscosity, as is known to those skilled in the art and always observable under such conditions for polyalkylene terephthalates, is the desired state.

The melt stability is determined by time-resolved MVR measurements according to ISO 1133 at 260° C. and a test weight of 2.16 kg. The MVR value is determined at 260° C. after residence times of 5 and 20 minutes. A reduction in the MVR value indicates an increase in melt viscosity. Thus a molding material for which the MVR value increases slightly as a result of prolonged residence at 260° C. may be regarded as melt-stable.

In the context of the present application the melt viscosity was determined relative to shear viscosity (unit of measurement Pa·s) according to ISO 11443. A good flow behavior is characterized by a low melt viscosity at typical shear rates corresponding to processing conditions (for example Eta=1500 s⁻¹)

In the case of articles of manufacture according to the invention, good mechanical properties in the context of the present invention feature high values for Izod impact resistance. Impact resistance describes the ability of a material of construction to absorb impact energy without fracturing. The test for Izod impact resistance according to ISO 180 is a standard method for determining the impact resistance of materials. This involves first holding an arm of a pendulum impact tester at a particular height (=constant potential energy) and finally releasing it. The arm strikes the sample and the sample breaks. The impact energy is determined from the energy absorbed by the sample. Impact resistance is calculated as the ratio of impact energy to specimen cross section (unit of measurement: kJ/m²). In the context of the present invention, impact resistance was determined to ISO 180-1U at 23° C.

In the context of the present invention the surface quality of articles of manufacture based on compositions according to the invention was examined and visually appraised on test specimens having dimensions of 60 mm×60 mm×2 mm. Decisive assessment criteria were gloss, smoothness, color and uniform structure of the surface.

### PREFERRED EMBODIMENTS OF THE INVENTION

The present invention preferably relates to compositions, molding materials and articles of manufacture containing
a) at least one polyalkylene terephthalate,
b) at least one copolymer of at least one olefin and at least one acrylic ester or methacrylic ester of an aliphatic alcohol, wherein the melt flow index (MFI) according to ISO 1133 of the copolymer is not less than 50 g/10 min, preferably 150 g/10 min, and said index is measured/determined at 190° C. and a test weight of 2.16 kg, and
c) at least one additive based on molecules having 2 or more epoxy, anhydride or carbodiimide groups per molecule
   with the proviso that
   per 100 parts by mass of the component a) the component b) is employed in amounts in the range from 0.1 to 35 parts by mass and the component c) is employed in amounts in the range from 0.1 to 25 parts by mass
   and component a) is not in the form of a blend with polycarbonate and component c) contains no bromine.

The present invention preferably relates to compositions, molding materials or articles of manufacture containing
a) at least one polyalkylene terephthalate,
b) at least one copolymer of an olefin and of an acrylic ester of an aliphatic alcohol, wherein the melt flow index (MFI) according to 180 1133 of the copolymer is not less than 50 g/10 min, preferably 150 g/10 min, and said index is measured/determined at 190° C. and a test weight of 2.16 kg, and
c) at least one additive based an epoxidized natural oils, epoxidized fatty acid esters or synthetic epoxidized compounds having 2 or more epoxy groups per molecule.

The present invention preferably relates to compositions, molding materials or articles of manufacture containing
a) at least one polyalkylene terephthalate,
b) at least one copolymer of an olefin and of an acrylic ester of an aliphatic alcohol, wherein the melt flow index (WI) according to ISO 1133 of the copolymer is not less than 60 g/10 min, preferably 150 g/10 min, and said index is measured/determined at 19° C. and a test weight of 2.16 kg, and
c) at least one additive based on epoxidized natural oils, epoxidized fatty acid esters or synthetic epoxidized compounds having 2 or more epoxy groups per molecule
with the proviso that
per 100 parts by mass of the component a) the component b) is employed in amounts in the range from 0.1 to 35 parts by mass and the component c) is employed in amounts in the range from 0.1 to 35 parts by mass
and component a) is not in the form of a blend with polycarbonate and component c) contains no bromine.

The present invention preferably relates to compositions, molding materials or articles of manufacture containing
a) polybutylene terephthalate,
b) at least one copolymer of an olefin and of an acrylic ester of an aliphatic alcohol, wherein the melt flow index (NI FI) according to ISO 1133 of the copolymer is not less than 50 g/10 min, preferably 150 g/10 min, and said index is measured/determined at 190° C. and a test weight of 2.16 kg, and
c) at least one additive based on epoxidized natural oils, epoxidized fatty acid esters or synthetic epoxidized compounds having 2 or more epoxy groups per molecule

The present invention preferably relates to compositions, molding materials or articles of manufacture containing
a) polybutylene terephthalate,
b) at least one copolymer of an olefin and of an acrylic ester of an aliphatic alcohol, wherein the melt flow index (MFI) according to ISO 1133 of the copolymer is not less than 50 g/10 min, preferably 150 00 min, and said index is measured/determined at 190° C. and a test weight of 2.16 kg, and
c) at least one additive based on epoxidized natural oils, epoxidized fatty acid esters or synthetic epoxidized compounds having 2 or more epoxy groups per molecule
with the proviso that
per 100 parts by mass of the component a) the component b) is employed in amounts in the range from 0.1 to 35 parts by mass and the component c) is employed in amounts in the range from 0.1 to 25 parts by mass
and component a) is not in the form of a blend with polycarbonate and component c) contains no bromine.

The present invention preferably relates to compositions, molding materials or articles of manufacture containing in addition to the components a), b) and c) also component d) at least one filler and/or reinforcer.

The present invention preferably relates to compositions, molding materials or articles of manufacture containing in addition to the components a), b), c) and d) or instead of d) also at least one impact modifier.

The present invention preferably relates to compositions, molding materials or articles of manufacture containing in addition to the components a), b), c), d) and a) or instead of d) and/or a) also f) at least one further additive distinct from the components b) to a).

The present invention preferably relates to compositions, molding materials or articles of manufacture containing per 100 parts by mass of component a) the component d) in amounts in the range from 5 to 150 parts by mass.

The present invention preferably relates to compositions, molding materials or articles of manufacture containing per 100 parts by mass of component a) the component e) in amounts in the range from 6 to 60 parts by mass.

The present invention preferably relates to compositions, molding materials or articles of manufacture containing per 100 parts by mass of component a) the component f) in amounts in the range from 0 to 100 parts by mass.

The invention further relates to the use of compositions containing the components a), h) and c) and optionally d) and/or e) and/or f) for producing molding materials/articles of manufacture.

The invention further relates to a process for enhancing the melt stability of polyalkylene terephthalate-based molding materials/articles of manufacture producible therefrom, preferably PBT-based articles of manufacture, by addition of at least one copolymer of at least one olefin and at least one methacrylic ester or acrylic ester of an aliphatic alcohol, wherein the melt flow index (MFI) according to ISO 1133 of the copolymer is not less than 50 g/10 min, preferably 150 g/10 min, and said index is measured/determined at 190° C. and a test weight of 2.16 kg, and at least one additive based on molecules having 2 or more epoxy, anhydride or carbodiimide groups per molecule, preferably an additive based on molecules having 2 or more epoxy groups per molecule, wherein this additive contains no bromine.

In one embodiment the invention relates to a process for enhancing the hydrolysis stability of polyalkylene terephthalate-based articles of manufacture, preferably FBI-based articles of manufacture, by addition of at least one copolymer of at least one olefin and at least one methacrylic ester or acrylic ester of an aliphatic alcohol, wherein the melt flow index (MFI) according to ISO 1133 of the copolymer is not less than 50 g/10 min, preferably 150 g/10 min, and said index is measured/determined at 190° C. and a test weight of 2.16 Kg, and at least one additive based on molecules having 2 or more epoxy, anhydride or carbodilmidize groups per molecule, preferably an additive based on molecules having 2 or more epoxy groups per molecule, wherein this additive contains no bromine.

For clarity, it should be noted that the scope of the present invention encompasses all the definitions and parameters mentioned hereinafter in general terms or specified within areas of preference, in any desired combinations. The present invention relates to the compositions according to the invention, to molding materials producible therefrom, and in turn to articles of manufacture producible from the molding materials containing at least one composition according to the invention. Cited standards are to be understood as referring to the version in force on the filing date unless otherwise stated. While DIN EN ISO 10927 specifies a general method for determining the average molar mass and the molar mass distribution of polymers in a molar mass range of 2000 g/mol to 20 000 g/mol by matrix-assisted laser desorption/ionization time-of-flight mass spectrometry, in the context of the present invention said standard also provides reliable values for component c) in the molar mass range of 500 g/mol to 1000 g/mol and is/was therefore employed accordingly. (Meth)acrylic ester in the context of the present invention is to be understood as meaning methacrylic ester and/or acrylic ester.

The preparation of compositions according to the invention for producing melt-stable molding materials for further use for producing articles of manufacture, preferably by injection molding, in extrusion or for blow molding is effected by mixing the individual components in at least one mixing assembly, preferably a compounder, particularly preferably a co-rotating twin-screw extruder. This affords melt-stable molding materials according to the invention as intermediate products. These molding materials—also referred to as thermoplastic molding materials may either consist exclusively of components a), b) and c), or else may additionally comprise at least one of the components d), e) or f). The compositions, molding materials or articles of manufacture according to the invention may or may not contain the components d), e) and f). According to the invention, possible combinations for the compositions, molding materials or articles of manufacture are:

a), b), c)

a), b), c), d)

a), b), c), e)

a), b), c), f)

a), b), c) d), e)

a), b), c), d), f)

a), b), c), d), e), f)

Component a)

Polyalkylene terephthalates in the context of the invention are reaction products of aromatic dicarboxylic acids or the reactive derivatives thereof, preferably dimethyl esters or anhydrides, and aliphatic, cycloaliphatic or araliphatic dials, and mixtures of these reaction products.

Preferred polyalkylene terephthalates may be produced from terephthalic acid (or reactive derivatives thereof) and aliphatic or cycloaliphatic diols having 2 to 10 carbon atoms by known methods (Kunststoff-Handbuch, vol. VIII, p. 995 FF, Kari-Hansen-Verlag, Munich 1973).

Preferred polyalkylene terephthalates contain at least 80 mol %, preferably 90 mol %, based on the dicarboxylicacid, of terephthalic acid radicals and at least 80 mol %, preferably at least 90 mol %, based on the diol component, of ethylene glycol and/or propane-1,3-diol and/or butane-1,4-diol radicals.

The preferred polyalkylene terephthalates may contain in addition to terephthalic acid radicals up to 20 mol % of radicals of other aromatic dicarboxylic acids having 8 to 14 carbon atoms or radicals of aliphatic dicarboxylic acids having 4 to 12 carbon atoms, such as radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid.

In addition to ethylene glycol and/or propane-1,3-diol glycol and/or butane-1,4-diol glycol radicals the preferred polyalkylene terephthalates may contain up to 20 mol % of other aliphatic diets having 3 to 12 carbon atoms or cycloaliphatic dials having 6 to 21 carbon atoms, in particular radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2 methylpentane-2,4-diol, 2,2,4-trimethylpentane-1,3-diol, 1,6,2-ethylhexane-1,3-diol, 2,2-diethylpropane-1,3-diol, hexane-2,5-diol, 1,4-dl(β-hydroxyethoxy)benzene, 2,2-bis(4-hydroxycyclohexyl)propane, 2,4-dihydroxy-1,1,3,3-tetramathylcyclobutane, 2,2-bis(3-β-hydroxyethoxyphenyl)propane and 2,2-bis(4-hydroxypropoxyphenyl)propane (DE-A 24 07 674, DE-A 24 07 776, DE-A 27 15 932).

The polyalkylene terephthalates may be branched through incorporation of relatively small amounts of tri- or tetrahydric alcohols or tri- or tetrabasic carboxylic acid, as described for example in DE-A 19 00 270, Preferred branching agents are trimesic acid, trimallitic acid, trimethylalethane and trimethylolpropane, and pentaerythritol.

It is advisable to use not more than 1 mol % of the branching agent, based on the add component.

Particular preference is given to polyalkylene terephthalates produced solely from tarephthalic acid and reactive derivatives thereof, preferably dialkyl esters thereof, and ethylene glycol and/or propane-1,3-diol and/or butane-1,4-diol and/or 1,4-cyclohexanedimethanol, in particular polyethylene and polybutylene terephthalate, and mixtures of these polyalkylene terephthalates.

Preferred polyalkylene terephthalates also include co-polyalkylene terephthalates produced from at least two of the abovementioned acid components and/or from at least two of the abovementioned alcohol components; particularly preferred co-polyalkylene terephthalates are polyethylene glycol/butane-1,4-diol) terephthalates.

The thermoplastic polyalkylene terephthalates employable according to the invention may also be used in admixture with other polyalkylene terephthalates and/or further polymers.

The polybutylene terephthalate (PBT) [CAS No. 24968-12-5] preferably employable as component a) according to the invention is produced from terephthalic acid or the reactive derivatives thereof and butanediol by known methods (Kunstatoff-Handbuch, Vol. VIII, p. 695 ff, Karl Harmer Verlag, Munich 1973).

The PBT employable as component a) preferably contains at least 80 mol %, preferably at least 90 mol %, based on the dicarboxylic acid, of terephthalic acid radicals.

In one embodiment the PBT preferably employable as component a) according to the invention may contain in addition to terephthalic acid radicals up to 20 mol % of radicals of other aromatic dicarboxylic acids having 8 to 14 carbon atoms or radicals of aliphatic dicarboxylic acids having 4 to 12 carbon atoms, in particular radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid or 2,5-furandicarboxylic acid.

In one embodiment the PBT preferably employable as component a) according to the invention may comprise in addition to butanediol up to 20 mol % of other aliphatic dials having 3 to 12 carbon atoms or up to 20 mol % of cycloaliphatic dials having 6 to 21 carbon atoms, preferably radicals of propane-1,3-diol, 2-ethylpropane-1,3-diol, neopentyl glycol, pentane-1,5-diol, hexane-1,6-diol, 1,4-cyclohexanedimethanol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-6-hydroxyethoxyphenyl)propane and 2,2-bis(4-hydroxypropoxyphenyl)propane.

PBT preferably employable as component a) preferably has an it viscosity according to EN ISO 1628/5 in the range from 40 to 170 cm³/g, particularly preferably in the range from 50 to 150 cm³/g, very particularly preferably in the range from 65 to 135 cm³/g, in each case measured in phenol/o-dichlorobenzene (1:1 parts by weight) at 25T; in an Ubbelohde viscometer. The intrinsic viscosity iV, &so referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer). The VN [ml/g] is obtained from the measurement of the solution viscosity in a capillary viscometer, for example an Ubbelohde viscometer. The solution viscosity is a measure of the average molecular weight of a plastics material The determination is effected with dissolved polymer, using various solvents, preferably m-cresol, tetrachloroethane, phenol, 1,2-dichlorobenzene, and concentrations. The viscosity number VN makes it possible to monitor the processing and performance characteristics of plastics. In this connection also see: http://de.wikipedia.org/wiki/Viskosimetrie and “http://de.wikipedia.org/wiki/Mark-Houwink-Gleichung”.

The PBT preferably employable as component a) according to the invention may also be employed in admixture with other polymers, preferably with polyethylene terephthalate (PET) and/or polycyclohexylene dimethylene terephthalate (PCT). The production of such PBT blends employable according to the invention, in particular PBT-PET blends or PBT-PCT blends, is effected by compounding. During such a compounding operation, customary additives, in particular mold release agents or elastomers, may additionally be added to the melt to improve the properties of the blends. Blends of PBT with polycarbonate are not encompassed by the subject matter of the present invention.

PBT employable in accordance with the invention may be obtained from Lanxess Deutschland GmbH, Cologne under the name Pocan® B 1300.

Component b)

As component b) the compositions according to the invention contain at least one copolymer of at least one olefin, preferably a-olefin, and at least one methacrylic ester or acrylic ester of an aliphatic alcohol, wherein the MFI of the copolymer b) is not less than 50 g/10 min, preferably 150 g/10 min. The copolymer employable as component b) preferably contains no further constituents, i.e. only the two components olefin and (meth)acrylic ester.

In a preferred embodiment component b) is a component made of only one olefin, preferably a-olefin, and only one acrylic ester of an aliphatic alcohol, wherein the MFI of the copolymer h) is not less than 50 g/10 min, preferably 150 g/10 min.

It is preferable when component b) contains less than 4% by weight, based on 100% by weight of the component b), particularly preferably less than 1.5% by weight and very particularly preferably 0% by weight of monomer units containing further reactive functional groups preferably selected from the group comprising oxetanes, imides, aziridines, furans, acids, amines, oxazolines.

Preferred olefins, in particular a-olefins, as a constituent of component b) comprise carbon atoms in a number in the range from 2 to 10, Preferred define may be unsubstituted or substituted with one or more aliphatic, cycloaliphatic or aromatic groups.

Preferred olefins are selected from the group comprising ethene, propene, 1-butene, 1-pentene, 1-hexene, 1-octene, 3-methyl-1-pentene. Particularly preferred define are ethene and propene, very particular preference being given to ethene.

Likewise suitable are mixtures of the olefins described.

In a more preferred embodiment the further reactive functional groups, selected from the group comprising oxetanes, imides, aziridines, furans, acids, amines, oxazolines, of component b) are introduced into the copolymer exclusively via the olefin.

The content of the olefin in the copolymer is preferably in the range from 50% to 90% by weight, particularly preferably in the range from 55% to 75% by weight, based on 100% by weight of the component b).

The copolymer is also defined by the second constituent in addition to the olefin. Suitable as the second constituent are alkyl or arylalkyl esters of methacrylic acid or acrylic acid whose alkyl or arylalkyl group is formed from 1 to 30 carbon atoms, preferably 3 to 20 carbon atoms. The alkyl or arylalkyl group may be linear or branched and contain cycloaliphatic or aromatic groups, and may additionally also be substituted by one or more ether or thioether functions.

The alkyl or arylalkyl group of the methacrylic or acrylic ester is preferably selected from the group comprising 1-propyl, 1-butyl, 1-pentyl, 1-hexyl, 2-hexyl, 3-hexyl, 1-heptyl, 3-heptyl, 1-octyl, 2-ethylhex-1-yl, 1-nonyl, 1-decyl, 1-dodecyl, 1-lauryl and 1-octadecyl. Preference is given to alkyl or arylalkyl groups having 3 to 20 carbon atoms.

Likewise suitable are mixtures of the acrylic esters or methacrylic esters described.

According to the invention particular preference is given to the use of more than 60 parts by mass, particular preference to the use of more than parts by mass and very particular preference to the use of 100 parts by mass of 2-ethylhexyl acrylate based on the total amount of 100 parts by mass of component b).

In a further preferred embodiment the further reactive functional groups, selected from the group comprising oxetanes, imides, aziridines, furans, acids, amines, oxazolines, of copolymer b) are introduced into the copolymer b) exclusively via the methacrylic ester or via the acrylic ester.

The content of the methacrylic ester or of the acrylic ester in the copolymer b) is in the range from 10 to 50 parts by mass, preferably in the range from 25 to 45 parts by mass, based on 100 parts by mass of the component b).

Features of copolymers b) employable according to the invention include not only the chemical composition but also the low molecular weight. Accordingly, only copolymers b) having an MFI measured at 190° C. under a load of 216 kg of at least 50 g/10 min, preferably of at least 150 g/10 min and particularly preferably of 300 g/10 min are suitable for the compositions according to the invention. It is very particularly preferable according to the invention to employ as component b) the copolymer of ethene and 2-ethylhexyl acrylate [CAS No. 26984-27-0] which is commercially available under the brand Lotryl® from Arkema Group, France.

The copolymers employable as component b) may also act as flow promoters in the molding materials according to the invention.

Component c)

Employed as component c) is at least one additive based on molecules having 2 or more epoxy, anhydride or carbodiimide groups per molecule, wherein this additive contains no bromine. This is preferably at least one epoxidized natural oil or at least one epoxidized fatty acid ester or at least one synthetic epoxidized compound. It is particularly preferable when additives of component c) have at least one terminal epoxy group but altogether at least two epoxy groups per molecule.

Preferred epoxidized natural oils are based on at least one oil from the group of olive oil, linseed oil, peanut oil, palm oil, soybean oil and cod liver oil. Particular preference is given to linseed oil or soybean oil, very particular preference to linseed oil.

The average molecular weight of the epoxidized natural oils employable as component c) is preferably in the range from 500 to 1000 g/mol and is determined by matrix assisted laser desorption/ionization time-of-flight mass spectrometry according to DIN EN ISO 10927, Linseed or soybean oils preferably employable according to the invention are mixtures of trans-fatty acids where the C₁₈-carboxylic acid content predominates.

Epoxidized natural oils are generally produced by methods familiar to those skilled in the art; see Angew. Chem. 2000, 112, 2292-2310.

Preferred epoxidized fatty acid esters are obtained from saturated or unsaturated aliphatic carboxylic acids having 10 to 40 carbon atoms, preferably having 16 to 22 carbon atoms, by reaction with aliphatic saturated alcohols having 2 to 40 carbon atoms, preferably 2 to 6 carbon atoms.

It is preferable when mono- or dibasic carboxylic acids are concerned. It is particularly preferable to choose at least one carboxylic acid from the group of pelargonic acid, palmitic acid, lauric acid, margaric acid, dodecanedioic acid, behenic acid, stearic acid, capric acid, montanic acid, linoleic acid, linolenic acid and oleic acid.

Preferably employable aliphatic saturated alcohols are mono- to tetrahydric. It is particularly preferable when at least one alcohol is selected from the group of n-butanol, n-octanol, stearyl alcohol, ethylene glycol, propylene glycol, neopentyl glycol, pentaerythritol and glycerol. Glycerol is especially preferred.

Mixtures of different esters and/or oils may also be employed.

Introduction of the epoxy function into the abovementioned esters and/or oils is effected by reaction thereof with epoxidizing agents, preferably with peracids, in particular with peracetic acid. Such reactions are sufficiently well known to those skilled in the art.

The production of synthetic epoxidized compounds is likewise known to those skilled in the art. Preferred synthetic epoxidized compounds are polyglycidyl or poly(beta-methylglycidyl) ethers obtainable by reaction of a compound having at least two free alcoholic or phenolic hydroxyl groups and/or by reaction of phenolic hydroxyl groups with a substituted epichlorohydrin preferably under alkaline conditions or in the presence of an acidic catalyst and subsequent alkali treatment.

Preferred polyglycidyl or poly(beta-methylglycidyl) ethers derive from acyclic alcohols, in particular ethylene glycol, diethylene glycol and higher poly(oxyethylene) glycols, propane-1,2-diol or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, and from polyepichlorohydrins.

Alternatively preferred polyglycidyl or poly(beta-methylglycidyl) ethers derive from cycloaliphatic alcohols, in particular 1,3- or 1,4-dihydroxycyclohexane, bis(4-hydroxycyclohexyl)methane, 2,2-bis(4-hydroxycyclohexyl)propane or bis(hydroxymethyl)cyclohex-3-ene, or they comprise aromatic nuclei based on N,N-bis(8,2-hydroxyethyl)aniline or p,p′-bis(2-hydroxyethylamino)diphenylmethane.

Preferred synthetic epoxidized compounds are additionally based on mononuclear phenols, on polynuclear phenols or on condensation products of phenols with formaldehyde obtained under acidic conditions.

Preferred mononuclear phenols are resorcinol or hydroquinone.

Preferred polynuclear phenols are bis(4-hydroxyphenyl)methane, 2,2-bis(4-hydroxyphenyl)propane, 2,2-bis(3,5-dibromo4-hydroxyphenyl)propane or 4,4′-dihydroxydiphenylsulfone.

Preferred condensation products of phenols with formaldehyde are phenol novolacs.

Preferred aromatic epoxy compounds have 2 terminal epoxy functions.

Preferred aromatic epoxy compound having 2 terminal epoxy functions is an oligomeric reaction product of bisphenol A with epichlorohydrin according to formula (I)

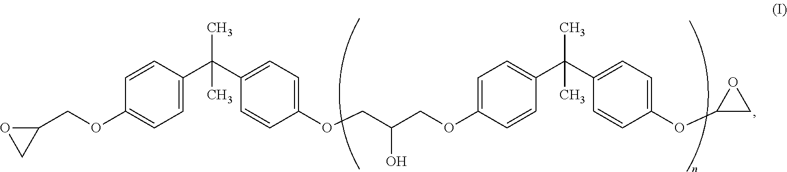

where n is in the range from 0 to 10, preferably where n is in the range from 1 to 8, particularly preferably where n is in the range from 1 to 6, wherein n represents the average number of

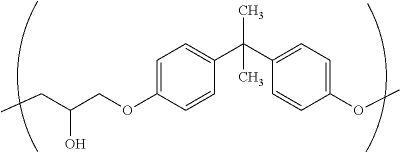

units in formula (I).

It is preferable to employ an aromatic epoxy compound having 2 terminal epoxy functions according to formula (II)

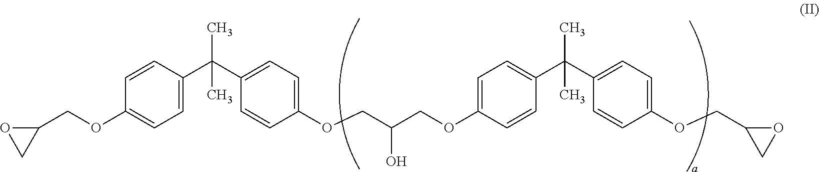

wherein a represents a number in the range from 0 to 10, preferably in the range from 1 to 8 particularly preferably in the range from 1 to 6, wherein a represents the average number of

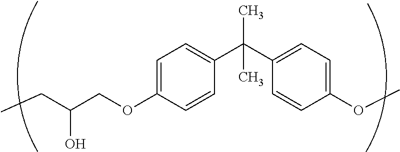

units in formula (II).

The additives based on molecules having 2 or more epoxy groups per molecule employable as component c) are alternatively also referred to as condensation product of epichlorohydrin and bisphenol A.

Compounds of formula (II) preferably employable as component c) according to the invention may be produced by a process according to US200210128428 A1.

A synthetic epoxy compound employable according to the invention, in particular an epoxy compound of formula (1/), preferably has a Mettler softening point according to CAN 51920 in the range from 0 to 150° C., particularly preferably 50° C. to 120° C., very particularly preferably in the range from 60° C. to 110° C. and in particular in the range from 75° C. to 95° C. The Mettler softening point is the temperature at which the sample flows out of a cylindrical nipple having an outflow opening of 635 mm in diameter, thus interrupting a light gate which lies 19 mm below. To this end, the sample is heated in air under constant conditions.

Preferably employable synthetic epoxy compounds, in particular epoxy compounds of formula (II), have an average epoxy equivalent weight (EEW, grams of resin containing one mole of epoxidically bonded oxygen) via titration according to DIN16945 in the range from 160 to 2000 Wed, preferably in the range from 250 to 1200 g/eq, particularly preferably in the range from 350 to 1000 Wed and especially preferably in the range from 450 to 800 g/eq.

Preferably employed as component c) is a poly(bisphenol A-co-epichlorohydrin) having a number-average molecular weight (Mₙ) determined by matrix-assisted laser desorption/ionization time-of-flight mass spectrometry (MALDI-TOF) according to EN ISO 10927 in the range from 600 to 1800 g/mol, preferably in the range from 900 to 1200 g/mol (corresponds to a in the range from 2 to 3 in formula (II)).

Preferably employed as component c) is a poly(bisphenol A-co-epichlorohydrin) having an epoxy index determined according to ISO 3001 in the range from 450 to 600 grams per equivalent.

Poly(bisphenol A-co-epichlorohydrin) employable as component c) according to the invention includes mixtures of molecules according to formula (II) that are obtainable from Leuna Harze GmbH, Leuna under the name Epilox®.

In a preferred embodiment of the present invention the compositions, molding materials and articles of manufacture contain no further components in addition to the components a), b) and c).

Component d)

Preferably employed as component d) is at least one filler or reinforcer. Preferably employed as component d) are at least one filler or reinforcer from the group of carbon fibers, glass beads, ground glass, amorphous silica, calcium silicate [CAS No. 1341-95-2], calcium metasilicate [CAS No. 10101-390], magnesium carbonate [CAS No. 546-93-0], kaolin [CAS No. 1332-58-7], calcined kaolin [CAS No. 92704-41-1], chalk [CAS No.1317-65-3], powdered or ground quartz [GAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8] and glass fibers [CAS No. 65997-17-3]. Particular preference is given to using glass fibers, especially preferably glass fibers of E-glass.

The glass fibers particularly preferred according to the invention preferably have a fiber diameter in the range from 7 to 18 μm, particularly preferably in the range from 8 to 15 μm, and are added in the form of continuous fibers or in the form of chopped or ground glass fibers.

According to “http://de.wikipedia.org/wiki/Faser-Kunststoff-Verbund”, distinction is made between a) chopped fibers, also known as short fibers, having a length in the range from 0.1 to 1 mm, b) long fibers having a length in the range from 1 to 50 mm and c) endless fibers having a length L>50 mm. fiber lengths may be determined for example by microfocus x-ray computed tomography (μ-CT); DGZIP annual conference 2007 —lecture 47.

The fibers are preferably modified with a size system or an adhesion promoter or adhesion promoter system, particularly preferably based on silane.

Very particularly preferred silane-based adhesion promoters for pretreatment are silane compounds of general formula (II)

(X—(CH₂)_{q})ₖ—Si—(O—CᵣH₂₄₊₁)₄₋ₖ (III)

In which the substituents are defined as follows:

X: NH₂—, HO—,

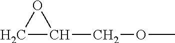

q: an integer from 2 to 10, preferably from 3 to 4,

r: an integer from 1 to 5, preferably from 1 to 2,

k: an integer from 1 to 3, preferably 1.

Especially preferred adhesion promoters are sane compounds from the group of aminopropyltrimethoxysilane, aminobutyltrimethoxysilane, aminopropyltriethoxysilane, aminobutyltriethoxysilane and the corresponding silanes comprising a glycidyl group as the substituent X.

For modification of the glass fibers the sane compounds are preferably used in amounts in the range from 0.05 to 2 parts by mass, particularly preferably in the range from 0.25 to 1.5 parts by mass and in particular in the range from 0.5 to 1 part by mass based on 100 parts by mass of glass fibers for surface coating.

The glass fibers may as a result of the processing to afford the molding material (compounding) or the article of manufacture producible therefrom have a lower d97 or d50 value in the molding material or in the article of manufacture than the originally employed glass fibers. The glass fibers may as a result of the processing to afford the molding material or the final article of manufacture have shorter length distributions in the molding material or Ira the final article of manufacture than originally used.

In a preferred embodiment of the present invention the compositions, molding materials and articles of manufacture contain no further components in addition to the components a), b), c) and d).

Component e)

Impact modifiers preferably employable according to the invention include inter alia one or more graft polymers of

E.1 5 to 95 parts by mass, preferably 30 to 90 parts by mass, of at least one vinyl monomer on

E.2 95 to 5 parts by mass, preferably 70 to 10 parts by mass, of one or more graft substrates having glass transition temperatures of <10° C., preferably <0° C., particularly preferably <−20° C., in each case based on 100 parts by weight of the component e).

The graft substrate E.2 generally has a median particle size (d50) in the range from 0.05 to 10 μm, preferably in the range from 0.1 to 5 μm, particularly preferably in the range from 0.15 to 1 μm.

Monomers E.1 are preferably (C₁-C₈)-alkyl (meth)acrylates, in particular (C₁-C₈)-alkyl methacrylates, in particular methyl methacrylate, ethyl methacrylate and/or glycidyl methacrylate, n-butyl acrylate, t-butyl acrylate and/or derivatives, in particular anhydrides and imides of unsaturated carboxylic acids, in particular maleic anhydride or N-phenylmaleimide.

Preferred monomers E.1 is methyl methacrylate.

Likewise suitable monomers E.1 are mixtures of

E1.1 50 to 99 parts by mass of vinylaromatics and/or ring-substituted vinylaromatics, in particular styrene, a-methylstyrene, p-methylstyrene, p-chlorostyrene, and/or (C₁-C₈) alkyl methacrylates, in particular methyl methacrylate, ethyl methacrylate, and

E.1.2 1 to 50 parts by mass of vinyl cyanides, in particular unsaturated nitriles such as acrylonitrile and methacrylonitrile, and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide.

Preferred monomers E.1.1 are selected from at least one of the monomers styrene, α-methylstyrene and methyl methacrylate; preferred monomers E.1.2 are selected from at least one of the monomers acrylonitrile, maleic anhydride, glycidyl methacrylate and methyl methacrylate.

Graft substrates E.2 suitable for the graft polymers employable in the elastomer modifiers are, for example, acrylate rubbers, diene rubbers, EPDM rubbers, i.e. those based on ethylene/propylene and optionally diene, and also polyurethane, silicone, chloroprene and ethylene/vinyl acetate rubbers. EPDM stands for ethylene-propylene-diene rubber.

Preferred graft substrates E.2 are acrylate rubbers based on graft substrates E.2 which preferably polymers of alkyl acrylates, optionally with up to 40 wt %, based on E.2, of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, preferably chloroethyl acrylate, glycidyl esters, end mixtures of these monomers. Graft polymers comprising butyl acrylate as the core and methyl methacrylates as the shell are particularly preferred.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably from 0.02 to 5 parts by mass, in particular 0.05 to 2 parts by mass, based on the graft substrate E.2.

For cyclic crosslinking monomers having at least 3 ethylenically unsaturated groups it is advantageous to restrict the amount to below 1 part by mass of the graft substrate E.2.

Preferred “other” polymerizable, ethylenically unsaturated monomers which, in addition to the acrylic esters, may optionally be used to prepare the graft substrata E.2 are acrylonitrile, styrene, α-methylstyrene, acrylamides, vinyl C₁-C₈alkyl ethers, methyl methacrylate, glycidyl methacrylate, butadiene. Preferred acrylate rubbers as the graft substrate E.2 are emulsion polymers having a gel content of at least 60 parts by mass.

Likewise suitable graft substrates E.2 are diene rubbers, in particular based on butadiene, isoprene etc., or mixtures of diene rubbers or copolymers of diene rubbers or mixtures thereof with further copolymerizable monomers, especially as per E1.1 and E.1.2, with the proviso that the glass transition temperature of component E.2 is <10° C., preferably <0° C., particularly preferably <−10° C.

Graft substrates E.2 suitable here are preferably ABS polymers (emulsion, bulk and suspension ABS), wherein ABS stands for acrylonitrile-butadiene-styrene, as described, for example, in DE-A 2 035 390 or in DE-A 2 248 242 or in Ullmann, Enzyklopädie der Technischen Chemie, vol. 19 (1980), p. 280 ff. The gel fraction of the graft base E.2 is preferably at least 30 parts by mass, particularly preferably at least 40 parts by mass (measured in toluene). Very particular preference is given to a rubber based on an acrylonitrile-butadiene-styrene copolymer. The elastomer modifiers/graft polymers are produced by free-radical polymerization, preferably by emulsion, suspension, solution or bulk polymerization, in particular by emulsion or bulk polymerization.

Since, as is well known, the graft monomers are not necessarily fully grafted onto the graft substrate in the grafting reaction, according to the invention “graft polymers” are to be understood as also meaning products produced by (co)polymerization of the graft monomers in the presence of the graft substrate and co-obtained in the workup.

Further preferably suitable graft substrates according to E.2 are silicone rubbers having graft-active sites, as are described in DE-A 3 704 657, DE-A 3 704 655, DE-A 3 631 540 and DE-A 3 631 539.

As well as elastomer modifiers based on graft polymers, it is likewise possible to use elastomer modifiers which are not based en graft polymers and have glass transition temperatures of <10° C., preferably <0° C. particularly preferably <−20° C. These preferably include elastomers having a block copolymer structure and additionally thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

In a preferred embodiment of the present invention the compositions, molding materials and articles of manufacture contain no further components in addition to the components a), b), c), d) and e) or the compositions, molding materials and articles of manufacture contain no further components in addition to the components a), b), c) and e).

Component f)

In one embodiment the compositions according to the invention contain in addition to the components a) to c) or in addition to the components a) to d) also at least one additive f) distinct from the components b), c), d) and e) and selected from the group of phosphite stabilizers, mold release agent. UV stabilizers, heat stabilizers, gamma-ray stabilizers, antistats, flow promoters, flame retardants, fire retardancy additives, emulsifiers, nucleating agents, plasticizers, lubricants, dyes and pigments.

These and further suitable additives are described, for example, in Gächter, Müller, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives employable as component f) may be used individually or in admixture/in the form of masterbatches.

It is preferable when at feast one phosphite stabilizer is used as component f). It is preferable to employ at least one phosphite stabilizer from the series tris(2,4-di-tert-butylphenyl) phosphite (Irgafos® 166, BASF SE, [CAS No. 31570-04-4]), bis(2,4-di-tert-butylphenyl)pentaerythrityl diphosphite (Ultranox® 626, Chemtura, [CAS No. 26741-53-7]), bis(2,6-di-tert-butyl-4-methylphenyl)pentaerythrityl diphosphite (ADK Stab PEP-36, Adeka, [CAS No. 80693-00-1]), bis(2,4-dicumylphenyl)pentaerythrityl diphosphite (Doverphos® S-9228, Dover Chemical Corporation, [CAS No. 154862-43-8]), tris(nonylphenyl) phosphite (Irgafos® TNPP, BASF SE, [CAS No. 26523-78-4]), (2,4,6-tri-t-butylphenol)-2-butyl-2-ethyl-1,3-propanediol phosphite (Ultranox® 641, Chemtura, [CAS No. 161717-32-4]) or Hostanox® P-EPQ.

It is preferable when at least one mold release agent is used as component f). Preferred mold release agents employed are at least one selected from the group of ester wax(es), pentaerythritol tetrastearate (PETS), long-chain fatty acids, salt(s) of long-chain fatty acids, amide derivative(s) of long-chain fatty acids, montan waxes and low molecular weight polyethylene or polypropylene wax(es), or ethylene homopolymer wax(es).

Preferred long-chain fatty acids are stearic acid or behenic acid. Preferred salts of long-chain fatty acids are calcium stearate or zinc stearate. A preferred amide derivative of long-chain fatty acids is ethylenebisstearylamide. Preferred montan waxes are mixtures of straight-chain saturated carboxylic acids having chain lengths of from 28 to 32 carbon atoms.

Preferably employed heat or UV stabilizers are sterically hindered phenols, hydroquinones, aromatic secondary amines such as diphenylamines, substituted resorcinols, salicylates, benzotriazoles and benzophenones, and also variously substituted representatives of these groups or mixtures thereof.

Preferably employed plasticizers are dioctyl phthalate, dibenzyl phthalate, butyl benzyl phthalate, hydrocarbon oils or N-(n-butyl)benzenesulfonamide.

Nucleating agents employable as component f) according to the invention are preferably sodium or potassium salts of acetate, salicylate, stearate, saccharinate and partly saponified montan waxes and ionomers, sodium or calcium phenyl phosphinate, aluminum oxide, silicon dioxide or talc Particular preference is given to using talc [CAS No.14807-96-6] as a nucleating agent, in particular microcrystalline talc. Talc is a phyllosilicate having the chemical composition Mg₃[Si₄O₁₀(OH)₂], which, depending on the modification, crystallizes as talc-1A in the triclinic crystal system or as talc-2M in the monoclinic crystal system (http://de.wikipedia.org/wiki/Talkum). Talc for use in accordance with the invention is commercially available, for example, under the name Mistron® R10 from Imerys Talc Group, Toulouse, France (Rio Tinto Group).

Use

The present invention further relates to the use of at least one copolymer of at least one olefin and at least one acrylic ester or methacrylic ester of an aliphatic alcohol, wherein the melt flow index (MFI) according to ISO 1133 of the copolymer is not less than 50 g/10 min and said index is measured/determined at 190° C. and a test weight of 2.16 kg, and at least one additive based on molecules having 2 or more epoxy, anhydride or carbodiimide groups per molecule in at least one polyalkylene terephthalate for producing polyalkylene terephthalate-based compositions, molding materials or articles of manufacture.

The invention preferably relates to the use of the components b) and c) for providing polyalkylene terepthalate-based molding materials which have a high melt stability under processing conditions and show no increase in melt viscosity in the course of or as a consequence of processing and which exhibit a low melt viscosity and a good flow behavior during processing.

The invention particularly preferably relates to the use of the components b) and c) for providing polyalkylene terephthalate-based articles of manufacture having a high hydrolysis resistance which is preferably not reduced even by addition of a flow promoter.

Process

The preparation of compositions according to the invention for producing molding materials for further use in injection molding or in extrusion is effected by mixing the individual components in at least one mixing assembly, preferably a compounder. To produce a polyalkylene terephthalate based article of manufacture the molding materials are subjected to further processing, preferably to an injection molding process or an extrusion. The processes of injection molding and of extrusion of thermoplastic molding materials are known to those skilled in the art.

The present invention thus relates to a process for producing articles of manufacture, preferably hydrolysis-stable articles of manufacture, particularly preferably hydrolysis-stable articles of manufacture without the hydrolysis stability being reduced by the addition of a flow promoter, by processing compositions containing the components a), b) and c) in at least one mixing assembly, preferably a compounder, to afford molding materials and subjecting these to further processing, preferably to an injection molding process or an extrusion.

Processes according to the invention for producing polyalkylene terephthalate-based articles of manufacture by extrusion or injection molding are performed at melt temperatures in the range from 230 to 330° C., preferably in the range from 250 to 300° C., and optionally also at pressures of not more than 2500 bar, preferably at pressures of not more than 2000 bar, particularly preferably at pressures of not more than 1500 bar and very particularly preferably at pressures of not more than 750 bar.

In extrusion it is preferable to distinguish between profile extrusion and sequential coextrusion. Sequential coextrusion involves extruding two different materials successively in an alternating sequence. This forms a preform having a material composition that differs section by section in the extrusion direction. It is possible to provide particular article sections with specifically required properties through appropriate material selection, for example for articles with soft ends and a hard middle section or integrated soft bellow regions (Thielen, Hartwig, Gust, “Blasformen von Kunstotoffholkörpern” [Blow-molding of Hollow Plastics Bodies], Carl Hanser Verlag, Munich 2006, pages 127-129).

The process of injection molding comprises melting (plasticizing) the raw material, preferably in pellet form, in a heated cylindrical cavity, and injection thereof as an injection molding material under pressure into a temperature-controlled cavity. Employed as raw material are compositions according to the invention which have preferably already been processed into a molding material by compounding, where said molding material has in turn preferably been processed into a pellet material. After cooling (solidification) of the molding material injected into the temperature-controlled cavity the injection-melded part is demolded.

The following are distinguished:

1. plasticization/melting

2. injection phase (truing operation)

3. hold pressure phase (because of thermal contraction during crystallization)

4. demolding

An injection molding machine comprises a closure unit, the injection unit, the drive and the control system. The closure unit includes fixed and movable platens for the mold, an end platen, and tie bars and drive for the movable mold platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pellet material. The problem of melt backflow inside the screw (leakage flow) is solved by nonreturn valves.

In the injection mold, the incoming melt is then separated and coded and the article of manufacture to be fabricated is thus fabricated. Two halves of the mold are always needed for this purpose. In injection molding, the following functional systems are distinguished:
runner system
shaping inserts
venting
machine mounting and force absorption
demolding system and motion transmission
temperature control

In contrast to injection molding, in extrusion an endless plastics extrudate, here of a molding material according to the invention, is employed in an extruder, wherein the extruder is a machine for producing thermoplastic moldings/articles of manufacture. The following are distinguished:

single-screw extruder and twin-screw extruder and the respective sub-groups

conventional single-screw extruder, conveying single-screw extruder,

contra-rotating twin-screw extruder and co-rotating twin-screw extruder.

Extrusion plants are composed of the elements extruder, mold, downstream equipment, extrusion blow molds. Extrusion plants for producing profiles are composed of the elements:

extruder, profile mold, calibrating unit, cooling zone, caterpillar take-off and roller take-off, separating device and tilting chute.

Articles of manufacture obtainable according to the invention are preferably materials exposed to aqueous media, atmospheric humidity or water spray. The demands of the automotive industry on the components to be used in motor vehicles are increasing continually and thus also keep presenting new challenges for the materials used. Plugs, plug connectors and housing parts employed in under-hood applications in automobiles must therefore pass ever more stringent tests. Cycle tests in the temperature range of −40° C. to +150° C. under humid conditions are not uncommon and require materials modified with specific hydrolysis stabilizers. For example PBT is produced from terephthalic acid or else dimethyl terephthalate and 1,4butanediol by a polycondensation reaction with elimination of water. However, this polycondensation is reversible by hydrolysis at high temperatures and high relative humidity (RH). In the reaction of PBT with water the polymer chain is cleaved to form fragments having a smaller chain length right down to the reactants terephthalic acid and 1,4 butane diol. This means that the esterification is reversed (deesterification). Even a hydrolyzed proportion of 0.01% can result in significant degradation of viscosity and the molecular weight. Compared to thermooxidative or thermal degradation, in the case of hydrolysis the destruction of a polymer can be accelerated 1000-fold or even 10 000-fold by the presence of catalytically active additives. In order to impede or at least retard hydrolysis, various stabilizers may be added. The commonly used stabilizers may on the one hand scavenge the water but on the other hand may also reconstruct previously destroyed polymer chains. The hydrolysis of inventive articles of manufacture based on polyalkylene terephthalates is impeded or at least retarded by addition of the components b) and c).

Such hydrolysis-stabilized articles of manufacture may be found in particular in motor vehicles, in the electronics, telecommunications, information technology or computer industry and also in the household, sports, medical or entertainment sector.

Preferred according to the invention are compositions and molding materials and articles of manufacture producible therefrom containing a) POT, b) copolymer of ethene and 2-ethylhexyl acrylate and c) epoxidized linseed oil or oligomeric 2,2-bis(4-(2,3-epoxypropoxy)phenyl)propane or a reaction product of phenol and epichlorohydrin.

Preferred according to the invention are compositions and molding materials and articles of manufacture producible therefrom containing a) PBT, b) copolymer of ethene and 2-ethylhexyl acrylate and c) epoxidized linseed oil or oligomeric 2,2-bis(4-(2,3-epoxypropoxy)phenyl)propane or a reaction product of phenol and epichlorohydrin

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine.

Preferred according to the invention are compositions and molding materials and articles of manufacture producible therefrom containing a) POT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin and d) glass fibers.

Preferred according to the invention are compositions and molding, materials and articles of manufacture producible therefrom containing a) PBT, b) copolymer of ethane and 2 ethylhexyl acrylate, c) epoxidized linseed oil or oligomeric 2,2-bis(4-(epoxypropoxy)phenyl)propane or a reaction product of phenol and epichlorohydrin and d) glass fibers

with the proviso that

per 100 parts by mass of the component a) the component b) is employed in amounts in the range from 0.1 to 35 parts by mass and the component c) is employed in amounts in the range from al to 25 parts by mass

and component a) is not in the form of a blend with polycarbonate and component c) contains no bromine. Preferred according to the invention are compositions and molding materials and articles of manufacture producible therefrom containing a) PBT, h) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers and e) methyl methacrylate-butyl acrylate graft copolymer.

Preferred according to the invention are compositions and molding materials and articles of manufacture producible therefrom containing a) PBT, h) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers and e) methyl methacrylate-butyl acrylate graft copolymer

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine. Preferred according to the invention are compositions and molding materials and articles of manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) talc

with the proviso that

per 100 parts by mass of the component a) the component b) is employed in amounts in the range from 01 to 35 parts by mass and the component c) is employed in amounts in the range from 0.1 to 25 parts by mass

and component a) is not in the form of a blend with polycarbonate and component c) contains no bromine.

Preferred according to the invention are compositions and molding materials and articles of manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) talc

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine. Preferred according to the invention are compositions and molding materials and articles of manufacture producible therefrom containing a) PET, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) phosphite stabilizer.

Preferred according to the invention are compositions and molding materials and articles of manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) phosphite stabilizer with the proviso that

per 100 parts by mass of the component a) the component b) is employed in amounts in the range from 01 to 35 parts by mass and the component c) is employed in amounts in the range from 0.1 to 25 parts by mass

and component a) is not in the form of a blend with polycarbonate and component c) contains no bromine.

Preferred according to the invention are compositions and molding materials and articles of manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) talc and phosphite stabilizer.

Preferred according to the invention are compositions and molding materials and articles of manufacture producible therefrom containing a) FBI, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, a) methyl methacrylate butyl acrylate graft copolymer and f) talc and phosphite stabilizer

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine.

Preferred according to the invention are compositions and molding materials and articles of manufacture producible therefrom containing a) PBT, b) copolymer of ethene and 2-ethylhexyl acrylate, c) epoxidized linseed oil or oligomeric 22-bis(4-(2,3-epoxypropoxy)phenyl)propane or a reaction product of phenol and epichlorohydrin, d) glass fibers, a) methyl methacrylate-butyl acrylate graft copolymer and f) at least one fatty acid ester.

Preferred according to the invention are compositions and molding materials and articles of manufacture producible therefrom containing a) P81, b) copolymer of ethene and 2-ethylhexyl acrylate, c) epoxidized linseed oil or oligomeric 22-bis(4-(2,3-epoxypropoxy)phenyl)propane or a reaction product of phenol and epichlorohydrin, d) glass fibers, e) methyl methacrylate-butyl acrylate graft copolymer and f) at least one fatty acid ester

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine.

Preferred according to the invention are compositions and molding materials and articles of to manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, a) methyl methacrylate-butyl acrylate graft copolymer and f) talc and at least one fatty acid ester.

Preferred according to the invention are compositions and molding materials and articles of manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) talc and at least one fatty acid ester

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine.

Preferred according to the invention are compositions and molding materials and articles of manufacture producible therefrom containing a) PBT, b) copolymer of ethene and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, e) methyl methacrylate-butyl acrylate graft copolymer and f) talc, phosphite stabilizer and at least one fatty acid ester.

Preferred according to the invention are compositions and molding materials and articles of manufacture producible therefrom containing a) PBT, b) copolymer of ethane and 2-ethylhexyl acrylate, c) epoxidized linseed oil or oligomeric 2,2-bis(4-(2,3-epoxypropoxy)phenyl)propane or a reaction product of phenol and epichlorohydrin, d) glass fibers, a) methyl methacrylate-butyl acrylate graft copolymer and f) talc, phosphite stabilizer and at least one fatty acid ester

with the proviso that

per 100 parts by mass of the component a) the component b) is employed in amounts in the range from 0.1 to 35 parts by mass and the component c) is employed in amounts in the range from 0.1 to 25 parts by mass

and component a) is not in the form of a blend with polycarbonate and component c) contains no bromine.

### EXAMPLES

To produce inventive articles of manufacture based on inventive compositions the individual components were mixed in the melt in a twin-screw extruder (ZSK 32 Mega Compounder from Coperion Werner & Pfieiderer, Stuttgart, Germany) at temperatures in the range from 260 to 300° C., extruded, cooled in a water bath until pelletizable and pelletized. Before any further steps the pelletized material was dried at 120° C. in a vacuum drying cabinet for about 4 h.

The sheets and test specimens for the evaluations specified in Tables 1 to 3 were injection molded on a commercially available Arburg 320-210-500 injection molding machine at a melt temperature in the range from 250° C. to 270° C. and a mold temperature in the range from 75° C. to 85° C.

Test bars 80×10×4 mm (as per ISO 178)

Color sample plaques: 60×40×2 mm

Apart from the melt viscosity measurements and the measurements of the melt indices all of the evaluations specified in tables 1 to 3 were performed using the abovementioned test specimens.

Impact Resistance

The impact resistance of the articles of manufacture produced from the inventive composition in the form of test specimens having dimensions of 80×100×4 mm³ were determined in an impact test according to ISO 180-1U (IZOD) at 23° C. (unit kJ/m²).

Melt Viscosity

In the context of the present invention mail viscosity was determined according to ISO 11443 at the reported (apparent) shear rate and temperature with a Malvern RH7-000 instrument (cylinder diameter=15 mm; capillary diameter=1 mm; capillary length=32 mm) after drying of the pellet material at 120° C. for 4 hours in a vacuum dryer. The measurement yielded the apparent viscosity in Pa·s in each case.

MVR Melt Index (Melt Volume Flow Rate)

As a measure for melt stability, MVR measurements were performed according to ISO 1133 using a Zwick/Roell B4106.200 flow test apparatus after residence times of 5 minutes and 20 minutes. The measured result is reported in cm³ per 10 min.

Reactive polyester mixtures may undergo an increase in chain length and thus in viscosity over time due to exposure to heat. By contrast, in a standard polyester exposure to heat result in slight chain degradation.

The testing after a residence time of 5 minutes in the flow test apparatus allowed a comparative assessment of the chain/viscosity degradation in the melt during the preceding compounding in the twin-screw extruder. Finally, the testing after a residence time of 20 minutes afforded a direct comparison of the buildup or degradation of the composition in the melt and could therefore be assigned for example to processing steps in the melt after compounding (for example injection molding, hot runner). In this case an “unstable melt” was characterized by a buildup and thus by an increase in melt viscosity and, correspondingly, a smeller MVR value.

Hydrolysis

To measure hydrolysis resistance, test specimens produced from inventive molding materials containing the inventive compositions were stored in a steam sterilizer at 100° C. and 100% humidity. After 15 days of exposure to the humidity (hydrolysis) in each case the impact resistances of the stored articles of manufacture were determined in an impact test according to ISO 180-1U at 23° C. and the values according to table 1 were obtained. The impact resistance is reported in relative terms in percent (%) of the starting value.

Surface

The surface was examined and visually appraised using test specimens having dimensions of 60 mm×60 mm×2 mm. Decisive assessment criteria were gloss, smoothness, color and uniform structure of the surface.

Reactants

Component a): PBT, linear polybutylene terephthalate having an intrinsic viscosity of 93 g/cm³ measured in phenol: 1,2-dichlorobenzene 1:1 at 25° C.; (Pocan® B1300, commercially available product from Lanxess Deutschland GmbH, Cologne)

Component b) Copolymer of ethane and 2-ethylhexyl acrylate having an ethane content of 63% by weight and an MF of 550 (Lotryl® 37 EH 550 from Arkema, France) [CAS-No. 26984-27-0]

Component c1): Epilox®, oligomeric reaction product of bisphenol A and epichlorohydrin according to formula (II) (a 2−3) having CAS No. 25068-38-6 and having an epoxy equivalent weight (DIN 16945) in the range from 500 to 700 and a softening point (Mettler, DIN 51920) in the range from 75° C. to 90° C. from Leuna Harze GmbH, Leuna.

Component c2): Epoxidized linseed oil (epoxy content 8-10%). Edenol® B 316 Spezial from Emery Oligochemicals, Malaysia

Component d): Glass fiber sized with silane-containing compounds and having a diameter of 10 μm (CS 7967, commercially available product from Bayer Antwerpen N.V., Antwerp, Belgium)

Component e): Methyl methaycrylate/butyl acrylate copolymer consisting of a butyl acrylate core and a grafted-on MMA shell (70/30), Paraloid® EXL 3300, DOW Chemical AG, USA.

Component f): Employed as further additives were the following components commonly used in thermoplastic polyesters:

Nucleating agent: Talc [CAS No. 14807-95-6] in amounts from 0.01 to 0.55 parts by mass based on 100 parts by mass of component a)

Heat stabilizer Customary stabilizers based on phenyl phosphites in amounts of 0.01 to 0.55 parts by mass based on 100 parts by mass of component a)

mold-release agent: Commercially available fatty acid esters in amounts of 0.1 to 0.50 parts by mass based on 100 parts by mass of component a)

Pigments: Carbon black, organic dyes, each in amounts of 0 to 0.85 parts by mass based on 100 parts by mass of component a)

TABLE 1

| | Comparative 1 | Comparative 2 | Example 1 | Example 2 | Example 3 |
|---|---|---|---|---|---|
| Component a) | 100 | 100 | 100 | 100 | 100 |
| Component b) | — | | 10 | 10 | 10 |
| Component c1) | — | 3 | 3 | 3 | |
| Component c2) | | | | | 9 |
| Component d) | 43 | 47 | 49 | 52 | 43 |
| Component e) | — | 6 | | 7 | |
| Component f) | 1 | 1 | 1 | 1 | 1 |
| MVR (260° C., 2.16 kg) - 5 min | 17 | 11 | 17 | 13 | 18 |
| MVR (260° C., 2.16 kg) - | 24 | 8 | 23 | 17 | 19 |
| 20 min | | | | | |
| Melt stability | ++ | − | ++ | ++ | + |
| Melt viscosity at 260° C., | 138 | 120 | 85 | 90 | n.d. |
| Eta = 1500 s⁻¹ | | | | | |
| Izod impact resistance | n.d | + | + | + | n.d |
| Retained impact resistance | 13 | 42 | 68 | 55 | 55 |
| (Izod) after 15 d at 100° C., | | | | | |
| 100% relative humidity | | | | | |
| Surface quality of color | + | n.d | + | n.d. | n.d. |
| sample plaque [60 × 40 × 2 mm] | | | | | |

(reported amounts in parts by mass)

Comparison shows the results measured in the context of the present invention on a standard PBT comprising 30 parts by mass of glass fibers. The measurements confirmed that the melt stability of such a standard molding material composed of PBT and 30 parts by mass of glass fibers is very good (++) as apparent from the increase in the MVR at a relatively lengthy residence time at 260° C. Pocan® B3235 from Lanxess Deutschland GmbH, Cologne was used as the standard PBT GF 30.

By contrast, comparison 2 shows that the melt stability of a molding material composed of PBT, glass fibers, a reactive epoxy resin and an impact modifier (acrylate copolymer based on a methyl methacrylate/butyl acrylate copolymer) was not melt-stable (−−). This is apparent from the decrease in the MVR after a residence time of 20 min at 260° C. versus a residence time of 5 min.

By comparison, inventive molding materials as per examples 1 to 3 composed of a) PBT, b) are acrylate copolymer based on ethylhexyl acrylate and ethene, c) a reactive epoxy resin and d) glass fibers in turn exhibited very good melt stabilities comparable with comparison 1.

However, articles of manufacture produced from these inventive molding materials moreover showed a higher hydrolysis stability than the articles of manufacture based on melding materials from comparative examples 1 and 2!

Also, the results of the melt viscosity test for examples 1 and 2 were markedly lower than the melt viscosity values for the molding materials of comparative examples 1 and 2. The very good flow behavior was reflected in a low melt viscosity/shear viscosity at a high shear rate (1500 s⁻¹) which corresponded approximately to the shear rate during processing. The flowability of the molding materials from the inventive compositions exceeded the flowability of a standard PBT GF 30.

Furthermore, the mechanical properties (Izod impact resistance) according to ISO 180 of articles of manufacture based on the inventive molding materials, and the surface quality, were comparable with a standard PBT from comparison 1 which is known to those spilled in the art for good surface and mechanical properties.

Surprising to those skilled in the art is the fact that in example 2 the addition of the component b) to a PBT mixture that is actually not melt-stable and is described in comparison 2 nevertheless resulted in a good melt stability. Furthermore, an improved hydrolysis stability and a reduced melt viscosity compared to comparison 2 were attained here too.

Example 3 shows that an inventive molding material may also employ other epoxy sources, epoxidized linseed oil in this case, instead of a phenol-epichlorohydrin-based epoxy resin as an additive employable as component c).

Accordingly, Table 1 shows that the inventive compositions/molding materials and articles of manufacture producible therefrom according to examples 1 to 3 fulfilled all of the requirements stipulated in the discussion of the problem addressed by the present invention.

The mixtures of PBT comprising the combination of the components b) and c) employable according to the invention showed excellent melt stabilities, the molding materials exhibited excellent flow behavior and articles of manufacture produced therefrom featured good hydrolysis resistance, good mechanical properties and a good surface.

1. A composition, comprising:
a) at least one polyalkylene terephthalate,
b) at least one copolymer of:
at least one olefin, and
at least one acrylic ester or methacrylic ester of an aliphatic alcohol,
wherein the melt flow index according to ISO 1133 of the copolymer is not less than 50 g/10 min and ti the index is measured/determined at 190° C. and a test weight of 2.16 kg, and
c) at least one additive based on molecules having 2 or more epoxy, anhydride or carbodiimide groups per molecule.

2. The composition as claimed in claim 1, wherein the at least one additive c) comprises at least one of: at least one epoxidized natural oil, at least one epoxidized fatty acid ester, and at least one synthetic epoxidized compound.

3. The composition as claimed in claim 1, wherein the at least one additive c) is selected from additives having at least one terminal epoxy group but altogether at least two epoxy groups per molecule.

4. The composition as claimed in claim 2, wherein the epoxidized natural oils are based on at least one oil from the group consisting of olive oil, linseed oil, peanut oil, palm oil, soybean oil, and cod liver oil, preferably linseed oil or soybean oil, in particular linseed oil.

5. The composition as claimed in claim 4, wherein the epoxidized natural oils have an average molecular weight of 500 to 1000 g/mol, determined by matrix-assisted laser desorption/ionization time-of-flight mass spectrometry according to DIN EN ISO 10927.

6. The composition as claimed in claim 2, wherein the epoxidized fatty acid esters are esters obtained by contact of saturated or unsaturated aliphatic carboxylic acids having 10 to 40 carbon atoms with aliphatic saturated alcohols having 2 to 40 carbon atoms.

7. The composition as claimed in claim 6, wherein the aliphatic carboxylic acids comprise mono- or dibasic carboxylic acids selected from the group consisting of pelargonic acid, palmitic acid, lauric acid, margaric acid, dodecanedioic acid, behenic acid, stearic acid, capric acid, montanic acid, linoleic acid, linolenic acid, and oleic acid.

8. The composition as claimed in claim 6, wherein the aliphatic saturated alcohols are mono- to tetrahydric.

9. The composition as claimed in claim 8, wherein the alcohol is selected from the group consisting of n-butanol, n-octanol, stearyl alcohol, ethylene glycol, propylene glycol, neopentyl glycol, pentaerythritol, and glycerol.

10. The composition as claimed in claim 2, wherein the synthetic epoxidized compounds comprise polyglycidyl or poly(beta-methylglycidyl) ethers, wherein the ethers are obtained by reaction of a compound having at least two free alcoholic or phenolic hydroxyl groups and/or by reaction of phenolic hydroxyl groups with a substituted epichlorohydrin.

11. The composition as claimed in claim 10, wherein the polyglycidyl or poly(beta-methylglycidyl) ethers derive from ethylene glycol, diethylene glycol and higher poly(oxyethylene) glycols, propane-1,2-diol, poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, polyepichlorohydrins or 1,3- or 1,4-dihydroxycyclohexane, bis(4-hydroxycyclohexyl)methane, 2,2-bis(4-hydroxycyclohexyl)propane, 1,1-bis(hydroxymethyl)cyclohex-3-ene, or compounds comprising aromatic nuclei based on N,N-bis(-8,2-hydroxyethyl)aniline or p,p′-bis(2-hydroxyethylamino)diphenylmethane or are based on mononuclear phenols, on polynuclear phenols or on condensation products of phenols with formaldehyde obtained under acidic conditions.

12. The composition claimed in claim 11, wherein the condensation products of phenols with formaldehyde are phenol novolacs.

13. The composition as claimed in claim 1, wherein the at least one additive comprises an aromatic epoxy compound having 2 terminal epoxy functions in the form of an oligomeric reaction product of bisphenol A with epichlorohydrin of formula (I) 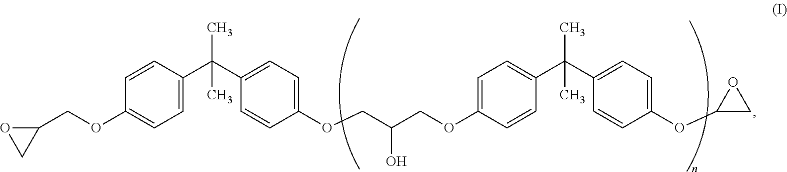
where n is 0 to 10, wherein n represents the average number of units of

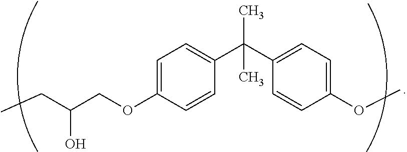

14. The composition as claimed in claim 13, wherein the additive comprises a poly(bisphenol A-co-epichlorohydrin).

15. A process for producing articles of manufacture, the process comprising processing compositions as claimed in claim 1 in at least one mixing assembly to produce molding materials, and subjecting these molding materials to further processing, preferably to an injection molding process or an extrusion.

16. A method for producing polyalkylene terephthalate-based compositions, the method comprising combining:
polyalkylene terephthalate,
at least one copolymer of at least one olefin and at least one acrylic ester or methacrylic ester of an aliphatic alcohol, wherein the melt flow index (MFI) according to ISO 1133 of the copolymer is not less than 50 g/10 min and said index is measured/determined at 190° C. and a test weight of 2.16 kg, and
at least one additive based on molecules having 2 or more epoxy, anhydride or carbodiimide groups per molecule.

17. Articles of manufacture comprising the composition of claim 1.
